(19) United States
(12) Patent Application Publication
(10) Pub. No.: US 2009/0171674 A1
(43) Pub. Date: Jul. 2, 2009

(54) PLAYBACK DEVICE SYSTEMS AND METHODS

(75) Inventor: Makoto Mitsumori, Hamamatsu-city (JP)

Correspondence Address: FOLEY & LARDNER, 555 South Flower Street, SUITE 3500, LOS ANGELES, CA, 90071-2411, US

(73) Assignee: Roland Corporation

(21) Appl. No.: 12/340,330

(22) Filed: Dec. 19, 2008

(30) Foreign Application Priority Data
Dec. 27, 2007 (JP) 2007-338062

(51) Int. Cl. G10L 19/00

(52) U.S. Cl. 704/500; 704/E19.001

(57) ABSTRACT

A playback device configured to play back audio in response to an instruction. Prior to the instruction, decoded audio data corresponding to a header (e.g., frame number 1 to N) of compressed audio data may be stored in audio cache memory. After the instruction, the decoded audio data may be outputted while a frame number N of the compressed audio data is decoded to produce intermediate data for decoding frame number (N+1). Accordingly, decoded audio data corresponding to frame number (N+1) and subsequent frames may be played backed continuous from the frame number N. Thus, compressed audio data can be played back soon after an instruction.

### CROSS-REFERENCE TO RELATED PATENT APPLICATIONS

Japan Priority Application 2007-338062, filed Dec. 27, 2007 including the specification, drawings, claims and abstract, is incorporated herein by reference in its entirety.

### BACKGROUND OF THE INVENTION

1. Field of the Invention

Embodiments of the present invention generally relate to playback device systems and methods, and, in specific embodiments, to audio playback device systems and methods for playing compression-encoded audio data after a playback start instruction.

2. Related Art

Audio devices that read and play back a continuous waveform signal stored in memory have been known to musical instrument players for some time. For example, Japanese Patent Application Laid-open No. H09-134177 discloses a sound source device for use with a musical instrument in which a plurality of continuous waveform signals are stored on the hard disk 42, wherein the continuous waveform signals designated by the number switch group 14 are played back.

With the sound source device, the type of the continuous waveform signal is designated by the number switch group 14. The designated type of the continuous waveform signal contains a header that is read from the hard disk 42 and stored in the waveform memory 12. When the start switch 14c is operated, the partial waveform signal (e.g., the header) stored in the waveform memory 12 is sequentially read out. During this time, the partial waveform signal that is continuous from the header of the continuous waveform signal stored in the hard disk 42 is sequentially written to the region where the readout of the waveform memory 12 ended. Accordingly, the continuous waveform signal stored on the hard disk 42 can be played back soon after a playback start instruction.

Over the years, audio signals have been compression encoded and stored to decrease a size of the information while maintaining high sound quality. Audio compression encoding methods of this type include MPEG-1 Audio (ISO/IEC 11172-3) Layer 3 (hereinafter called “MP3”) and MPEG-2 Advanced Audio Coding (ISO/IEC 13818-7) (hereinafter called “AAC”), and the like. As for MP3 and AAC, audio data is compression-encoded with temporal overlaps of the prescribed number of samples, for example, as discussed in Japanese Patent Application Laid-open No. 2001-127641.

Referring back to the audio device in Japanese Patent Application Laid-open No. H09-134177, the signal stored in the hard disk 42 is converted into a compression-encoded audio signal (compressed audio data), which raises the efficiency of the storage media. However, as mentioned above, as for most of the audio compression encoding methods, including MP3 and AAC, because audio data is compression-encoded with temporal overlaps, intermediate data obtained during the decoding process is necessary. Accordingly, when the compressed audio data stored in the hard disk 42 continuous from the header is to be decoded and the intermediate data does not exist, the compressed audio data cannot be decoded properly.

Moreover, if the compressed audio data stored in the hard disk 42 is decoded from the header after the start switch 14c is operated, play back cannot begin until the compressed audio data is read out and decoded from the hard disk 42.

### SUMMARY OF THE DISCLOSURE

An audio playback device for playing back audio in response to an audio playback start instruction may include, but is not limited, to an input means, a decoding means, a storage means, a first output means, and a second output means. The input means may be for inputting compressed audio data based on a playback start instruction, the compressed audio data being compression-encoded using temporal correlation. The decoding means may be for decoding the compressed audio data input by the input means based on the playback start instruction.

The storage means may be for storing first audio data corresponding to a header portion of the compressed audio data input by the input means based on the playback start instruction. The first output means may be for outputting the first audio data stored in the storage means based on the playback start instruction. The second output means may be for controlling the decoding means to sequentially decode from at least a reference position of the compressed audio data required to decode the compressed audio data corresponding to second audio data that is continuous from a last portion of the first audio data stored in the storage means. The second output means may be further configured for outputting the second audio data decoded by the decoding means continuous to the first audio data output by the first output means.

The storage means may store first audio data corresponding to a header portion of the compressed audio data input by the input means based on the playback start instruction. In a case where there is an audio playback start instruction, the first output means may output the first audio data stored in the storage means. Thus, audio corresponding to the header portion of the compressed audio data can be played soon after a playback start instruction. Moreover, such embodiments may reduce a time of decoding the compressed audio data.

Thus, in a case where there is an audio playback start instruction, the header of the audio may be played back soon after the audio playback start instruction. Then, decoded audio data continuous to the header may be played back. Accordingly, audio data that has been compression-encoded using time correlation can be played back soon after a playback start instruction.

In various embodiments, the device may further include a storage control means that may be for controlling the decoding means to decode the compressed audio data corresponding to the header portion into the first audio data prior to the playback start instruction. The storage control means may be further configured for storing the first audio data corresponding to the header portion decoded by the decoding means in the storage means. Thus in some embodiments, even in a case where the audio header has been stored as compressed audio data, the compressed audio data can be played back soon after an audio playback start instruction.

In various embodiments, the device may further include a storage position information extraction means that may be for extracting storage position information of at least the reference position of the compressed audio data required to decode the compressed audio data corresponding to the second audio data that is continuous from the last portion of the first audio data stored in the storage means in a case where the decoding means is controlled by the storage control means to decode the compressed audio data corresponding to the header portion.

The input means may be further configured to sequentially input from at least the reference position of the compressed audio data required to decode the compressed audio data corresponding to second audio data that is continuous from the last portion of the first audio data stored in the storage means based on the storage position information extracted by the storage position information extraction means in a case where the decoding means is controlled to sequentially decode from at least the reference position of the compressed audio data required to decode the compressed audio data corresponding to second audio data that is continuous from the last portion of the first audio data stored in the storage means.

Generally, with respect to compression-encoded audio data, because the data length in the audio data of one sample may be a variable length, to access an arbitrary time of the compressed audio data, it may be necessary to read the compressed audio data sequentially from the beginning and search for the arbitrary time of the compressed audio data. Thus, in some embodiments, because there may be no need to read compressed audio data from the beginning and search for the desired compressed audio data, a burden required in the processing of the search can be reduced. Furthermore, because the amount of data of the compressed audio data input in order to obtain the desired compressed audio data may be minimized, time required for inputting the desired compressed audio data may be minimized.

Furthermore, because the storage position information of that compressed audio data can be extracted, there may be no need to read separate compressed audio data from the beginning and search for the storage position of the desired compressed audio data in order to extract the storage position information. As such, the storage position information can be easily extracted.

An audio playback method may include, but is not limited to any one or combination of, (i) inputting compressed audio data based on a playback start instruction, the compressed audio data being compression-encoded using temporal correlation; (ii) decoding the inputted compressed audio data based on the playback start instruction; (iii) storing first audio data corresponding to a header portion of the inputted compressed audio data; (iv) outputting the stored first audio data based on the playback start instruction; (v) sequentially decoding from at least a reference position of the compressed audio data required to decode the compressed audio data corresponding to second audio data that is continuous from a last portion of the stored first audio data; and (vi) outputting the decoded second audio data continuous to the outputted first audio data.

A computer-readable audio data storage device for storing audio data usable by an audio data playback device to play back audio in response to a playback start instruction may include, but is not limited to, non-compressed audio data and compressed audio data. The non-compressed audio data may correspond to a header of the audio played back by the playback device. The compressed audio data may be partly overlapped with first audio data corresponding to the non-compressed audio data. The compressed audio data may be compression-encoded using temporal correlation. The compressed audio data may be at least a reference position of the compressed audio data required to decode the compressed audio data corresponding to second audio data that is continuous from a last portion of the non-compressed audio data. Thus, in some embodiments, audio data that has been compression-encoded using temporal correlation can be played back soon after a playback start instruction.

A playback device for playing data based on an instruction may include, but is not limited to, a processor, a storage medium, and an output device. The processor may be configured to decode a first portion of compressed data stored in a storage device into first data. The processor may be further configured to decode a second portion of the compressed data continuous from the first data into second data upon receiving the instruction. The storage medium may be for storing the first data. The output device may be for outputting the first data upon receiving the instruction and outputting the second data continuous from the first data. The second portion of the compressed data may be decoded based at least partially on the first portion of the compressed data.

In various embodiments, the second portion of the compressed data may be decoded based on data obtained in decoding the first portion of the compressed data. In various embodiments, the processor may be configured to decode the first portion of the compressed data into the first data prior to receiving the instruction. The storage medium may be configured to store the first data prior to receiving the instruction. In various embodiments, the compressed data may comprise compressed audio data. In various embodiments, the storage medium may comprise random access memory.

In various embodiments, the device may further include a first control for providing the instruction. In further embodiments, the first control may comprise a keyboard. In yet further embodiments, the device may further include a second control for assigning a compressed datum from the compressed data to a key of the keyboard.

In various embodiments, the first data may include first intermediate data. The processor may be configured to decode the second portion of the compressed data based on the first intermediate data.

In various embodiments, the storage medium may be configured to store location information corresponding to a position of the first portion of the compressed data. In some embodiments, the processor may be configured to retrieve the position of the first portion of the compressed data based on the location information to decode at least a portion of the second portion of the compressed data. In some embodiments, the position of the first portion of the compressed data may be a last portion of the portion of the first portion of the compressed data. In some embodiments, the location information may correspond to an amount of the first data of the compressed data decoded by the processor.

In various embodiments, the device may further include a storage device that may be for storing the compressed data. In various embodiments, data corresponding to the compressed data may be compressed in at least one of the MPEG-1 Audio Layer 3 format and the Advanced Audio Coding format. In various embodiments, the output device may comprise a speaker that may be configured to output first audio corresponding to the first data upon receiving the instruction and to output second audio corresponding to the second data continuous from the first audio.

### BRIEF DESCRIPTION OF THE DRAWINGS

FIG. 1 is a block diagram illustrating an electronic configuration of an electronic musical instrument according to an embodiment of the present invention;

FIGS. 2(a)-2(d) are diagrams illustrating a generalized operation of an electronic musical instrument according to an embodiment of the present invention;

FIG. 3 is a flowchart illustrating main processing in accordance with an embodiment of the present invention;

FIG. 4 is a flowchart illustrating cache processing in accordance with an embodiment of the present invention; and

FIG. 5 is a flowchart illustrating playback processing in accordance with an embodiment of the present invention.

### DETAILED DESCRIPTION OF THE PREFERRED EMBODIMENTS

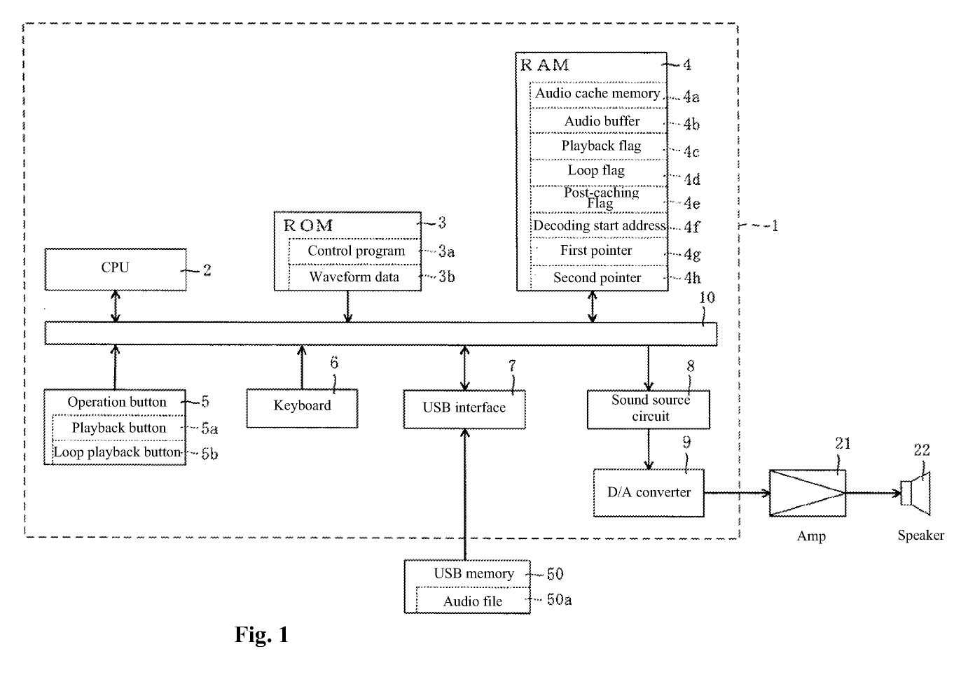

FIG. 1 is a block diagram illustrating an electronic configuration of a playback device, such as an electronic musical instrument 1, according to an embodiment of the present invention. The electronic musical instrument 1 may include, but is not limited to a CPU (Central Processing Unit) 2, ROM (Read Only Memory) 3, RAM (Random Access Memory) 4, an operation button 5, a keyboard 6, a USB interface 7, and a sound source circuit 8, which may be connected to each other via a bus line 10. The electronic musical instrument 1 may further include a D/A converter (digital-analog converter) 9 connected to a sound source circuit 8. An output of the D/A converter 9 may be transmitted to a speaker 22 via an amp 21 that may be externally provided.

The CPU 2 may be configured to control each of the elements in accordance with a program and data stored in the ROM 3 and/or the RAM 4, or in accordance with operation of the operation button 5 and/or the keyboard 6. In some embodiments, the CPU 2 may be configured to process multiple processes (i.e., multitask).

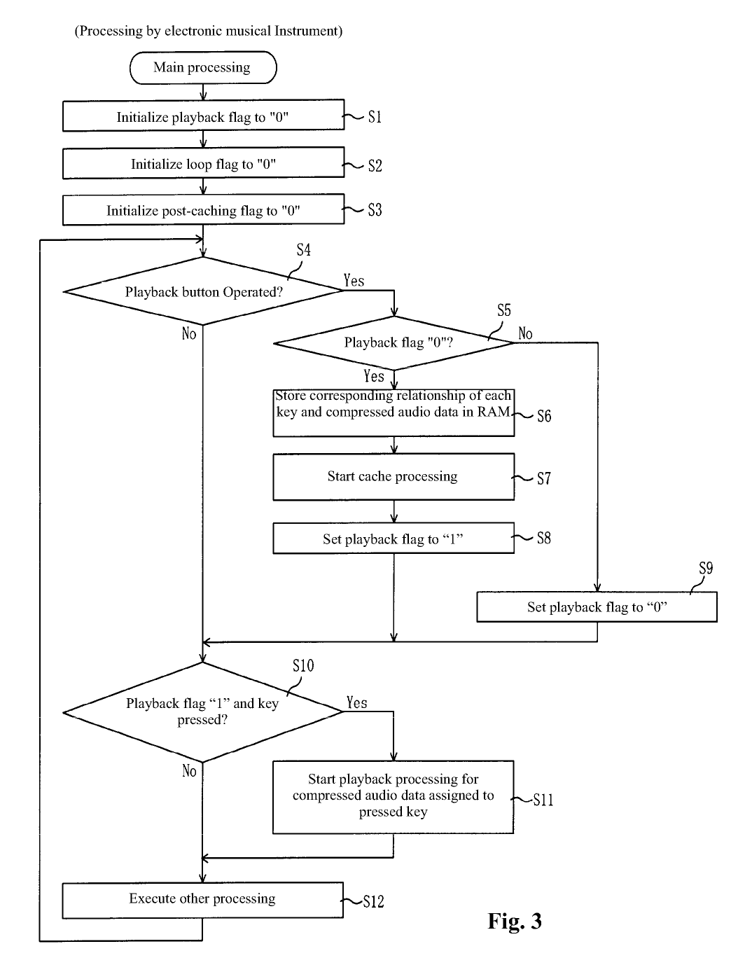

The ROM 3 may be non-rewritable memory, and may be for storing fixed value data that may include a control program 3a, which may be executable by the CPU 2, and waveform data 3b. The control program 3a may include programs corresponding to flowcharts illustrated in FIGS. 3-5. Returning to FIG. 1, the CPU 2 may be configured to execute the control program 3a to play back compressed audio data soon after a playback start instruction.

In some embodiments, the control program 3a may further include a decoding program that may be for decoding compressed audio data that has been compression-encoded, for example, in the MP3 format, the AAC format, or the like. For instance, by executing the decoding program, the CPU 2 may decode the compressed audio data in an audio file 50a.

A waveform of a musical note output from an electronic musical instrument 1 may be digitized in a PCM (Pulse Code Modulation) format to create a digitized waveform. The waveform data 3b may be the digitized waveform. The ROM 3 may contain respective waveform data 3b corresponding to each key in the keyboard 6. For example, in some embodiments, when a particular key is operated, the waveform data 3b corresponding to the particular key may be read by sound source circuit 8 from the ROM 3. Accordingly, the musical note based on the waveform data 3b corresponding to the particular key may be output to the speaker 22 via the D/A converter 9 and the amp 21 from the sound source circuit 8.

The keyboard 6 may be configured to carry out an output instruction of a musical note in the electronic musical instrument 1. The keyboard 6 may include a plurality of keys. Different waveform data 3b may be assigned to each key of the keyboard 6. By operating (e.g., pressing and/or releasing) a particular key of the keyboard 6, a prescribed musical note may be output from the speaker 22 based on the waveform data 3b corresponding to the particular key that was operated.

Furthermore, in a case where the electronic musical instrument 1 is in a playback mode (discussed later), a compressed audio file (e.g., audio file 50a) stored in an storage device (e.g., USB memory 50) may be assigned, for example as designated in a settings file (discussed later), to one or more keys of the keyboard 6. In some embodiments, the compressed audio file may be assigned to keys that make up 1 octave of a lower tone side (e.g., 12 keys) of the keyboard 6. For example, a storage device (e.g., USB memory 50) may include a plurality of compressed audio data from which a compressed audio file may be assigned to one or more of the keys of the lower tone side of the keyboard 6. When one of the keys is operated, the compressed audio data assigned to the key that was operated may be played back.

The RAM 4 may be memory for rewritably storing various types of data when the control program 3a is executed by the CPU 2. In various embodiments, the RAM 4 may be configured to carry out read operations and write operations at speeds higher than that of a storage device for containing compressed audio data, such as a USB memory 50.

The RAM 4 may include an audio cache memory 4a and an audio buffer 4b. The RAM 4 may also include a playback flag 4c, a loop flag 4d, a post-caching flag 4e, a decoding start address 4f, a first pointer 4g, and a second pointer 4h. In some embodiments, the RAM 4 may be configured such that when a frame of compressed audio data is decoded during a decoding process, intermediate data obtained by the decoding process of the frame is stored and retained in the RAM 4 until a next frame is decoded. The intermediate data obtained from decoding the frame may be used to decode the next frame.

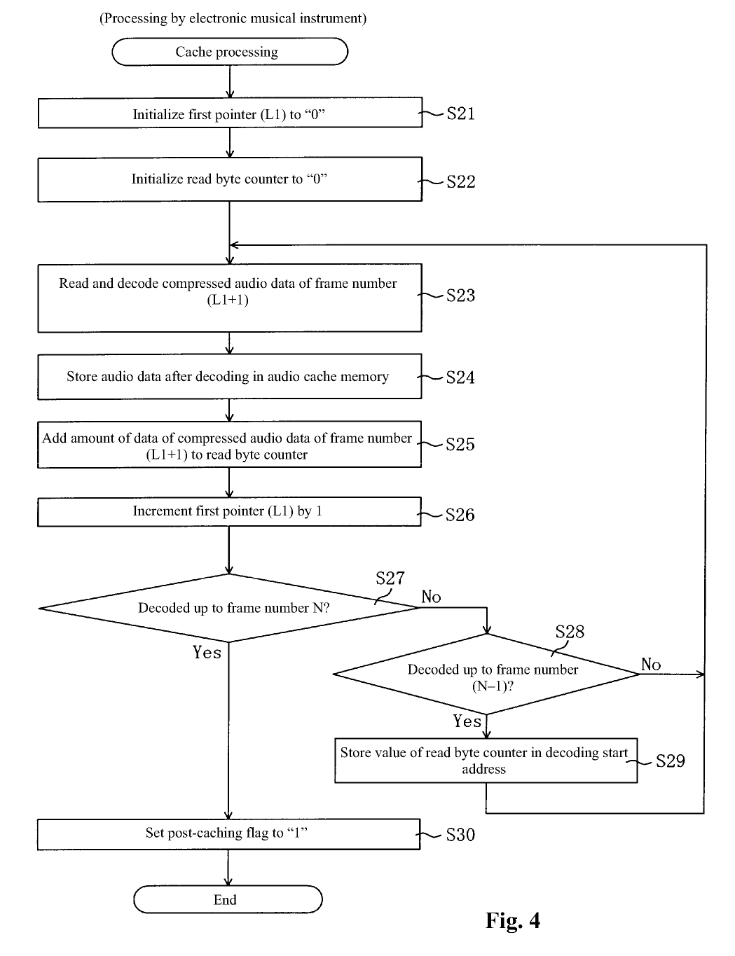

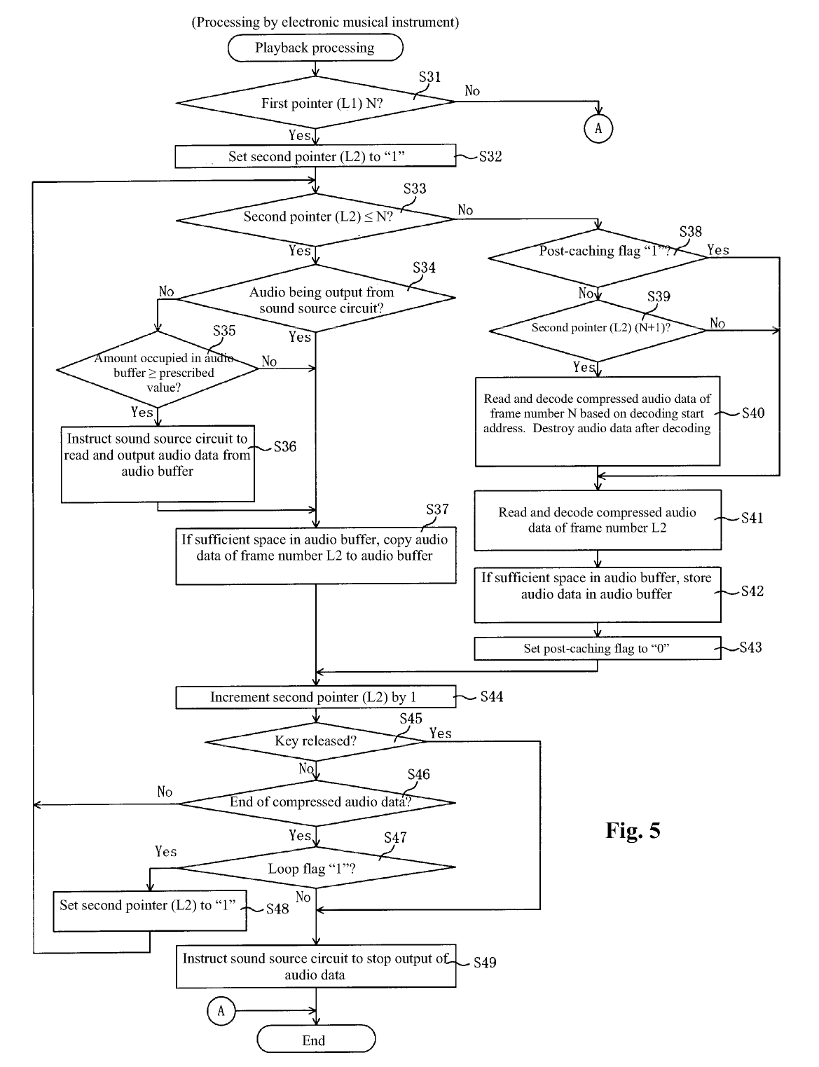

The electronic musical instrument 1 may include a plurality of each of the loop flag 4d, the post-caching flag 4e, the decoding start address 4f, the first pointer 4g, and/or the second pointer 4h, each of which may correspond to the keys to which compressed audio data may be assigned, respectively. In some embodiments, the RAM 4 may include multiple regions for storing intermediate data obtained from a frame corresponding to the keys. The multiple regions may correspond to the keys of the keyboard 6. Accordingly, the CPU 2 may be configured to execute processing (e.g., cache processing of FIG. 4 and playback processing of FIG. 5) independently corresponding to each compressed audio data. Thus, multiple musical notes may be played simultaneously.

In some embodiments, the RAM 4 may include multiple audio buffers 4b, which may correspond to a maximum number of musical notes that can be played simultaneously by the electronic musical instrument (e.g., 64 musical notes). The multiple audio buffers 4b may be used not only for the compressed audio data, but also for musical notes generated by the sound source circuit 8. Accordingly, the musical notes may be played back along with sounds generated by the sound source circuit 8.

The audio cache memory 4a may be memory for caching or otherwise storing audio data that is a decoded result of compressed audio data (i.e., audio data after decoding). In some embodiments, the audio cache memory 4a may cache or store up to a frame number N from a leading frame (e.g., frame number 1) from the compressed audio data respectively assigned to the keys of the lower tone side of the keyboard 6. The RAM 4 may include multiple audio memory caches each corresponding to a key of the lower tone side of the keyboard 6.

For example, in a case where the playback flag 4c is 0 and a playback button 5a (discussed later) is operated (e.g., pressed), the compressed audio data from frame number 1 to frame number N may be decoded to produce audio data. The audio data may be stored in the audio cache memory 4a corresponding to each key of the keyboard 6. In some embodiments, the audio data stored in the audio cache memory 4a may be retained while the corresponding compressed audio data is assigned to the keys of the lower tone side of the keyboard 6.

The audio buffer 4b may be a buffer, such as a ring buffer, or the like, of a FIFO (First In, First Out) type. In various other embodiments, the audio buffer 4b may be of any suitable buffer known in the art. The audio buffer 4b may be configured to maintain an output of audio data at a prescribed sampling speed. For example, the audio buffer 4b may be configured to store audio data temporarily in advance to maintain a steady output of audio data. When a key of the keyboard 6 is pressed, the CPU 2 may cause the key to correspond to an available audio buffer 4b and temporarily preserve the audio data to be played back by the key.

The audio data stored in the audio buffer 4b may be read out by the sound source circuit 8, for example, at specific time intervals. Accordingly, for example, the audio data may be output to the speaker 22 at a prescribed sampling speed via the D/A converter 9 and the amp 21. In some embodiments, a portion of the audio buffer 4b that contained the audio data read out from the audio buffer 4b may become free space. The CPU 2 may store additional audio data after separate decoding in the free space of the audio buffer 4b.

In some embodiments, the CPU 2 may be configured to monitor an amount of the audio buffer 4b being used. For example, the amount monitored by the CPU 2 may equal an amount of the audio data stored in the audio buffer 4b by the CPU 2 minus an amount of the audio data read by the sound source circuit 8. The electronic musical instrument 1, depending on the amount of the audio buffer 4b being used, may be configured to wait until audio data is read out by the sound source circuit 8 to provide additional free space in the audio buffer 4b.

The playback flag 4c may be a flag or the like for setting a playback function ON and OFF. In a case where the playback flag 4c is “1,” the electronic musical instrument 1 may be in a playback mode. In this mode and in a case where a particular key to which compressed audio data is assigned is operated, the compressed audio data assigned to the particular key may be played back. In some embodiments, in a case where an other key (e.g., a key that is not from the lower tone side of the keyboard 6) is pressed, waveform data corresponding to the other key may be read from the ROM 3 by the sound source circuit 8. Accordingly, the prescribed musical note may be outputted from the speaker 22 via the D/A converter 9 and the amp 21.

Furthermore, in a case where the playback flag 4c is “0,” the electronic musical instrument 1 may be in normal operation mode. In a case where the electronic musical instrument 1 is in the normal operation mode and a key of the keyboard 6 is operated (e.g., pressed), waveform data 3b corresponding to the key may be read from the ROM 3 and a prescribed musical note may be output from the speaker 22. The playback flag 4c may be initialized to “0” by the CPU 2 when, for example, a power source (not shown) for the electronic musical instrument 1 is turned on. In some embodiments, a playback button 5a, described later, may be configured to toggle the playback flag 4c between “0” and “1.”

The loop flag 4d may be a flag or the like that may be set to indicate whether or not playback of compressed audio data should be repeated once the compressed audio data has been played back. Loop playback may be carried out, for example, in a case where the loop flag 4d is set to “1” and may not be carried out when the loop flag 4d is set to “0.” The loop flag 4d may be initialized to “0,” by the CPU 2 when, for example, the power source (not shown) for the electronic musical instrument 1 is turned on. The loop flag 4d may be toggled, for example, in a case where a loop playback button 5b (discussed later) and a key of the keyboard 6 are operated simultaneously. The loop flag 4d may be toggled for each of the keys of the keyboard 6.

The post-caching flag 4e may be a flag or the like for indicating whether or not the RAM 4 contains intermediate data obtained by the decoding process of the frame number N. The post-caching flag 4e may be “1” in a case where the RAM 4 contains the intermediate data; the post-caching flag 4e may be “0” in a case where the RAM 4 does not contain the intermediate data. The post-caching flag may be for controlling which frame to decode in order to decode a frame number (N+1) properly.

For example, if the post-caching flag 4e is “0” (i.e., RAM 4 does not contain the intermediate data obtained by the decoding process of the frame number N), the compressed audio data of the frame number N may be read from the USB memory 50 and decoded accordingly to generate the intermediate data. Thus, the intermediate data obtained by the decoding process of the frame number N may be generated before decoding of the frame number (N+1). Then, the frame number (N+1) may be decoded, accordingly, using the intermediate data of the frame number N.

On the other hand, if the post-caching flag 4e is “1” (i.e., RAM 4 contains the intermediate data obtained by the decoding process of the frame number N), the compressed audio data corresponding to the frame number (N+1) may be read from the USB memory 50 and decoded accordingly. In such a case, the intermediate data that may be necessary to decode the frame number (N+1) is in the RAM 4 as indicated by the post-caching flag 4e being set to “1,” and thus there may not be a need to decode the frame number N.

The decoding start address 4f may indicate a position of the frame number N in the compressed audio data. For example, the decoding start address 4f may be a position relative to a position corresponding to a beginning of an Audio file 50a. The decoding start address 4f may be extracted by adding the amount of data of the compressed audio data corresponding to frame number 1 to frame number (N−1) read from the USB memory 50. Thus, in a case where the electronic musical instrument 1 plays back compressed audio data and corresponding to frame number N, the CPU 2 may reference the address stored in the decoding start address 4f. Accordingly, the compressed audio data of the frame number N may be immediately read or otherwise accessed from the USB memory 50.

The first pointer 4g may be a pointer for indicating a largest frame number (e.g., 1, 2, . . . , N) of the audio data stored in the audio cache memory 4a at a particular time. For example, in a case where a key to which compressed audio data is assigned is pressed and the corresponding compressed audio data is played back, the first pointer 4g may indicate whether or not the audio data after the decoding of the header (e.g., frame number 1 to frame number N) of the compressed audio data to be played back has been completely cached in the audio cache memory 4a.

The second pointer 4h may be a pointer for indicating a frame number of the audio data to be stored in the audio buffer 4b. In a case where the CPU 2 is to store the audio data of each frame in the audio buffer 4b, the second pointer 4h may be used to determine whether to copy the audio data from the audio cache memory 4a or to read and decode the compressed audio data from the USB memory 50.

In other words, in a case where the value of the second pointer 4h is N or less, the CPU 2 may read the audio data of the frame indicated by the second pointer 4h from the audio cache memory 4a and copy the audio data to the audio buffer 4b. Moreover, in a case where, the value of the second pointer 4h is N+1 or more, the CPU 2 may read and decode the compressed audio data of the frame indicated by the second pointer 4h from the USB memory 50 into audio data to generate audio data. The CPU 2 may be further configured to store the audio data corresponding to the frame number (N+1) in the audio buffer 4b.

The operation button 5 may be an operator, such as a button, or the like, for setting various types of settings and instructions for the electronic musical instrument 1. Operation conditions of the electronic musical instrument 1 may be set based on the operation button. The operation button 5, may include, but is not limited to, the playback button 5a and the loop playback button 5b.

The playback button 5a may be an operator, such as a button, or the like, configured to toggle the playback function ON and OFF, for example by toggling the playback flag 4c between “0” and “1.” Accordingly, the electronic musical instrument 1 may be switched between the playback mode and the normal operation mode. The loop playback button 5b may be an operator, such as a button, or the like, configured to set whether the compressed audio data is repeated upon being played back.

The USB interface 7 may be configured to transfer data between devices according to the USB standard. The USB interface 7 may include a connector (not shown) to allow the USB interface 7 to connect to an external device. For example, the USB memory 50 may be connected with the electronic musical instrument 1 via the USB interface 7. In other embodiments, the electronic musical instrument 1 may use any suitable interface, such as Firewire, or the like. In yet other embodiments, the interface 7 may be configured to communicate wirelessly with an external device.

The sound source circuit 8 may be a circuit for generating an audio data output based on the waveform data 3b or the audio data from the decoding of compressed audio data. In a case where a key of the keyboard 6 is pressed, the sound source circuit 8 outputs the waveform data 3b corresponding to the key from the ROM 3 in accordance with an instruction of the CPU 2. In a case where a key of the keyboard 6 to which compressed audio data is assigned is pressed, the audio data may be read from the audio buffer 4b assigned to the key. In some embodiments, the sound source circuit 8 may be configured to mix the waveform data 3b and/or the audio data by pressing multiple keys of the keyboard 6. The sound source circuit 8 may transmit the generated audio data to the D/A converter 9.

The D/A converter 9 may be configured to convert the audio data transmitted from the sound source circuit 8 to an analog signal. The amp 21, which may be externally provided, may be connected to the D/A converter 9 to amplify the analog signal. The speaker 22 may be connected to the amp 21 to output the amplified analog signal.

In various embodiments, the electronic musical instrument 1 may be configured to play back compressed audio data in a media file (e.g., an audio file 50a) stored in a storage medium, such as a hard drive, flash memory (e.g., USB memory 50), or the like soon after a start instruction. As noted earlier, an audio file 50a may be an MP3 format file that has been compression-encoded by the MPEG-1 Audio (ISO/IEC 11172-3) standard. However, in other embodiments, the file may be in any suitable format known in the art, such as, but not limited to, AAC format.

In some embodiments, the USB memory 50 may contain multiple compressed audio data stored as audio files 50a, or the like. In further embodiments, the compressed audio data may be compressed in the MP3 format in a manner known in the art. For instance, the MP3 format compression encodes as a unit a frame constituted by a prescribed number of samples of audio data sampled by a prescribed sampling frequency (e.g., 44.1 KHz). The respective frames are constituted using temporal correlation so that a sample of a certain frame overlaps with a sample of a previous frame and a sample of a next frame.

To decode audio data that is compression-encoded, for example, in the MP3 format, both intermediate data obtained by the decoding process of a frame number N and intermediate data obtained by the decoding process of a frame number (N−1) may be needed. In other words, a target frame (e.g., frame number N) can be decoded properly if the intermediate data obtained by the decoding process of a prior frame (e.g., frame number (N−1)) exists.

In some embodiments, the USB memory 50 may include a settings file containing information and various parameters for playing back the compressed audio data. For example, the setting information may designate the compressed audio data to be assigned to each key of the lower tone side of the keyboard 6. Accordingly, a user may edit the settings file to change the compressed audio data assigned to each of the keys. As a result, the electronic musical instrument 1 may assign compressed audio data to each of the keys of the lower tone side of the keyboard 6 in accordance with the setting information in the setting file. Thus, when a key is pressed, the compressed audio data assigned to the key may be played back.

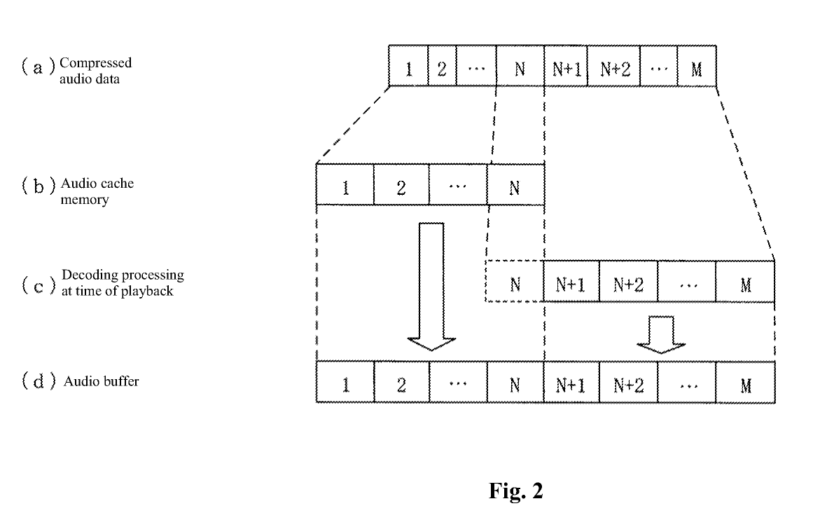

FIGS. 2(a)-2(d) are diagrams illustrating how compressed audio data may be processed according to an embodiment of the present invention. FIG. 2(a) illustrates an example of compressed audio data that may be assigned to a key of the lower tone side of the keyboard 6 (FIG. 1). The compressed audio data may comprise a plurality of frames ranging from frame number 1 to frame number M.

Next with reference to FIGS. 1 and 2(b), the header (e.g., frame number 1 to frame number N) of the compressed audio data may be decoded by the electronic musical instrument 1 in advance into audio data that may be stored in the audio cache memory 4a. In a case where a key to which compressed audio data is assigned is pressed, the electronic musical instrument 1 may copy the audio data stored in the audio cache memory 4a to the audio buffer 4d as shown in FIG. 2(d). Accordingly, returning to FIGS. 1 and 2(b), the audio data copied to the audio buffer 4b may be output from the speaker 22 via sound source circuit 8. Thus, the audio corresponding to the header (e.g., frame number 1 to frame number N) of the compressed audio data may be played back soon after the key of the keyboard 6 (FIG. 1) is pressed.

Then, while the audio data copied to the audio buffer 4b is being output from the speaker 22 by the sound source circuit 8, the electronic musical instrument 1 may begin decoding the frame number N again and frames after the frame number N, as shown in FIG. 2(c). In other cases (e.g., RAM 4 contains intermediate produced from decoding the frame number N), the electronic musical instrument 1 may begin decoding from the frame number (N+1).

As mentioned above, in some embodiments, in order to decode compressed data that has been compression-encoded in the MP3 format, intermediate data obtained from decoding a target frame (e.g., frame number (N+1)) and intermediate data obtained from decoding a previous frame (e.g., frame number N) from the target frame may be necessary. For example, as shown in FIG. 2(c), a sequential decoding process may be carried out from the frame number N to properly decode the audio data of the frame number (N+1) and following frame(s), which may be then stored in the audio buffer 4b (FIG. 1). Accordingly, the audio data of the frame number (N+1) and the following frame(s) may be output from the audio buffer 4b (FIG. 1) after the frame number N, as shown in FIG. 2(d). Thus, in some embodiments, an electronic musical instrument 1 may be configured to play back compressed audio data that has been compression-encoded soon after a playback start instruction, for example, by pressing a key of the keyboard 6 (FIG. 1).

FIG. 3 is a flowchart illustrating main processing in accordance with an embodiment of the present invention. With reference to FIGS. 1-3, the main processing may be for controlling operation of the electronic musical instrument 1 in accordance with the operation button 5 and the keyboard 6. The main processing may be initialized when the power source (not shown) is turned on, and may be executed repeatedly until the power source (not shown) is turned off.

In step S1, initialization of the main processing may occur, and the playback flag 4c may be set to “0.” Next in step S2, the loop flags 4d corresponding to each of the keys to which compressed audio data is assigned may be set to “0.” Next in step S3, the post-caching flags 4e corresponding to each of the keys to which compressed audio data is assigned may be set to “0.”

Next in step S4, a determination may be made as to whether or not the playback button 5a is operated (e.g., pressed). In a case where the playback button 5a is operated (S4: Yes), a determination may be made as to whether or not the playback flag 4c is “0” (step S5). As a result, in a case where the playback flag is “0” (S5: Yes) and the electronic musical instrument 1 is in the normal operation mode, the electronic musical instrument 1 may conclude that a user has operated the playback button 5a, and accordingly the playback mode has been set. As such, the settings file (not shown) stored in the USB memory 50 may be read. Then in step S6, a corresponding relationship between the keys of the lower tone side of the keyboard 6 and the compressed audio data assigned to each of the keys may be stored in the RAM 4.

Next in step S7, the cache processing (refer to FIG. 4) may begin. In some embodiments, the cache processing may be carried out for the compressed audio data assigned to each key, for example, when the playback button 5a is operated for a first time after the power source (not shown) of the electronic musical instrument 1 has been turned on. In further embodiments, after the playback button 5a is operated for the first time (e.g., after the power source (not shown) is turned on), the cache processing may be carried out for any keys that have had newly assigned compressed audio data. As a result of step S7, the compressed audio data corresponding to the headers of all the compressed audio data may be decoded and subsequently stored in the audio cache memory 4a before a playback instruction is provided (e.g., by pressing a key of the keyboard 6). Next in step S8, the playback flag 4c may be set to “1” such that the electronic musical instrument 1 may be in the playback mode. Then, the main processing may proceed to step S10.

In a case where, during step S5, the playback flag 4c is not “0” (i.e., the playback flag 4c is “1”) (S5: No), the electronic musical instrument 1 may be in the playback mode. Then, the playback flag 4c may be set to “0” such that the electronic musical instrument 1 may be in the normal operation mode (step S9). The main processing may then proceed to step S10.

In a case where, during step S4, the playback button 5a is not operated (e.g., not pressed) (S4: No), the electronic musical instrument 1 may conclude that the normal operation mode or the playback mode have not changed. Accordingly, steps S5-S9 may be skipped, and the main processing may proceed to step S10.

In step S10, in a case where the playback flag 4c is “1,” a determination may be made as to whether or not a key of the keyboard 6 to which compressed audio data is assigned has been pressed. If a key of the keyboard 6 has been pressed (S10: Yes), a playback start instruction may be given to start the playback processing (refer to FIG. 5) for the compressed audio data assigned to the key (step S11).

Accordingly, playback of the compressed audio data assigned to the key of the keyboard 6 that has been pressed may begin. Prior to the playback start instruction, the compressed audio data corresponding to the header of the compressed audio data may be decoded and stored in the audio cache memory 4a, as described earlier with respect to step S7. Thus, the audio data may be outputted from the audio cache memory immediately after a playback start instruction. Upon completion of step S11, the main processing may proceed to step S12. Similarly, if, during step S10, none of the keys to which compressed audio data is assigned has been pressed (S10: No), step S11 may be skipped, and the main processing may proceed to step S12.

In step S12, the electronic musical instrument 1 may execute other processing. For example, in a case where the loop playback button 5b is pressed and a key of the keyboard 6 to which compressed audio data is assigned has been pressed, the value of the loop flag 4d corresponding to the key may be toggled (e.g., “1” to “0” or “0” to “1”). As such, the user may be able to set a loop playback setting for each of the keys of the lower tone side of the keyboard 6.

Moreover, as another example, in a case where a key to which compressed audio data has not been assigned (e.g., all of the keys of the keyboard 6 when operated by the normal operation mode) is pressed, the electronic musical instrument may instruct the sound source circuit 8 to read from the ROM 3 the waveform data 3b corresponding to the key that has been pressed. As such, a prescribed musical note can be output from the speaker 22 via the sound source circuit 8, the D/A converter 9, and the amp 21.

Upon completion of step S12, the main processing may return to step S4. As such, steps S4-S12 may be repeatedly executed. As such, various processing may be carried out by operating the operation button 5 and the keyboard 6.

FIG. 4 is a flowchart illustrating cache processing in accordance with an embodiment of the present invention. With reference to FIGS. 1 and 4, the cache processing may be for decoding the header (e.g., frame number 1 to frame number N) of the compressed audio data to generate audio data and then storing the audio data in the audio cache memory 4a. As discussed with respect to the main processing (refer to FIG. 3), in a case where the playback flag 4c is “0” and the playback button 5a is operated (e.g., pressed), the cache processing (refer to FIG. 4) corresponding to each of the compressed audio data assigned to the keys of the lower tone side of the keyboard 6 may be each independently started.

The cache processing illustrated in FIG. 4 may represent one compressed audio datum assigned to a particular key of the keyboard 6 (FIG. 1). The cache processing may be carried out for the other keys as well. Because the cache processing of each of the keys may be similar, an explanation of the cache processing for the other keys has been omitted. With respect to FIGS. 1 and 4, reference to the audio cache memory 4a, the post-caching flag 4e, the decoding start address 4f, and the first pointer 4g may pertain to the particular key to which one compressed audio datum is assigned. A value stored in the first pointer 4g may be known as “L1.”

First in step S21, the value L1 of the first pointer 4g may be initialized to “0.” Next in step S22, a value of a read byte counter region in the RAM 4 may be initialized to “0.” The read byte counter region may be for adding an amount of data of the compressed audio data of each frame read from the USB memory 50.

Next in step S23, the cache processing may read and decode compressed audio data corresponding to a frame after the frame indicated by the first pointer 4g (hereafter called the “frame number (L1+1)”) to produce audio data. For example, when step S23 is first carried out, the compressed audio data corresponding to frame number 1 may be read and decoded. An amount of data of the compressed audio data of the frame number (L1+1) may be counted. Intermediate data obtained by the decoding process may be retained in the RAM 4.

Next in step S24, the audio data resulting from the decoding in step S23 may be stored in the audio cache memory 4a. As such, the frame number (L1+1) decoded in step S23 may be stored in the audio cache memory 4a. In step S25, the amount of data of the compressed audio data of the frame number (L1+1) counted during step S23 may be added to the value of the read byte region in the RAM 4. Accordingly, the amount of data of the compressed audio data for frame number 1 to frame number (L1+1) may be accumulated in the read byte region in the RAM 4. Next in step S26, the value L1 of the first pointer 4g may be incremented by 1. Accordingly, the largest frame number of the audio data stored in the audio cache memory 4a may be updated.

Next in step S27, a determination may be made as to whether or not the compressed audio data being processed by the cache processing has been decoded up to a frame number N. In a case where the compressed audio data being processed by the cache processing has not been decoded up to the frame number N (S27: No), a determination may be made as to whether or not the compressed audio data being processed by the cache processing has been decoded up to a frame number (N−1) (step S28). In a case where, the compressed audio data being processed by the cache processing has not been decoded up to the frame number (N−1) (S28: No), the cache processing may return to step S23 to repeat the steps that follow.

On the other hand, in a case where the compressed audio data being processed by the cache processing has been decoded up to the frame number (N−1) (S28: Yes) the value of the read byte counter region may be stored in the decoding start address 4f (step S29). As a result, the data amount of the compressed audio data of frame number 1 to frame number (N−1) may be accumulated in the read byte counter region. The data amount may correspond to a position of the frame number N in the compressed audio data. Consequently, the address in the compressed audio data of the frame number N may be stored in the decoding start address 4f. Because the address can be extracted easily, there may be no need to read separate compressed audio data and/or search for the address of the frame number N.

After step S29, the cache processing may return to step S23. Thus, in a case where, during step S27, the compressed audio data being processed by the cache processing has not been decoded up to the frame number N (S27: No), steps S23-S29 may be repeated. Accordingly, the compressed audio data corresponding to the header (e.g., frame number 1 to frame N) within one compressed audio datum may be decoded to produce audio data, which may be stored in the audio cache memory 4a.

On the other hand, in a case where, during step S27, the compressed audio data being processed by the cache processing has been decoded up to the frame number N (S27: Yes), steps S23-S29 may be skipped, and the post-caching flag 4e may be set to “1” (step S30). As a result, it can be known that the RAM 4 contains intermediate data obtained by the decoding process of the frame number N.

FIG. 5 is a flowchart illustrating playback processing in accordance with an embodiment of the present invention. The playback processing may be carried out to play back one compressed audio datum assigned to a particular key of the keyboard 6. The playback processing for the particular key may begin in a case where the playback flag is “1” and the particular key has been pressed.

As mentioned, the playback processing illustrated in FIG. 5 may represent one compressed audio datum assigned to a particular key of the keyboard 6 (FIG. 1). The playback processing may be carried out for the other keys as well. Because the playback processing of each of the keys may be similar, an explanation of the playback processing for the other keys has been omitted.

With reference to FIGS. 1 and 5, reference to the audio cache memory 4a, the loop flag 4d, the post-caching flag 4e, the decoding start address 4f, and the second pointer 4h may pertain to the particular key to which one compressed audio datum is assigned. The audio buffer 4b may be the audio buffer assigned by the CPU 2 when the particular key has been pressed. A value stored in the second pointer 4h may be known as “L2.”

First in step S31, a determination may be made as to whether or not a value L1 of the first pointer 4g is N. In a case where the value L1 of the first pointer 4g is not N (S31: No) (e.g., the audio data corresponding to the header (e.g., frame number 1 to frame number N) of one compressed audio datum may not yet have been completely stored in the audio cache memory 4a), the playback processing may end.

On the other hand, in a case where, during step S31, the value L1 of the first pointer 4g is N (S31: Yes) (e.g., the audio data corresponding to the header of one compressed audio datum (e.g., frame number 1 to frame number N) may be stored in the audio cache memory 4a), the value L2 of the second pointer 4h may be set to “1” (step S32). As such, the audio data to be stored in the audio buffer 4b may be set to the first frame (e.g., frame number 1).

Next in step S33, a determination may be made as to whether or not the value L2 of the second pointer 4h is N or less. In a case where the value L2 of the second pointer 4h is N or less (S33: Yes) (i.e., the audio data to be stored in the audio buffer 4b is frame number N or less), the playback processing may proceed to steps S34 to S37 to instruct the sound source circuit 8 to start audio output.

In step S34, a determination may be made as to whether or not audio is being output from the sound source circuit 8. In a case where audio is not being output from the sound source circuit 8 (S34: No), a determination may be made as to whether or not the amount occupied in the audio buffer 4b is a prescribed value or more (step S35). In a case where the amount occupied in the audio buffer 4b is the prescribed value or more (S35: Yes), the sound source circuit 8 may be instructed to read and output the audio data from the audio buffer 4b (step S36). Accordingly, the sound source circuit 8 may output audio. Moreover, because the amount occupied in the audio buffer 4b is the prescribed value or more, a risk of underflow (e.g., no audio data) in the audio buffer 4b may be reduced.

On the other hand, in a case where, during step S35, the amount occupied in the audio buffer 4b is not the prescribed value or more (S35: No), step S36 may be skipped to step S37, and thus there may be no instruction to the sound source circuit 8 to read and output audio data from the audio buffer 4b. Likewise, in a case where, during step S34, audio is being output from the sound source circuit 8 (S34: Yes), steps S35 and S36 may be skipped because the sound source circuit 8 is already outputting sound. In such a case, the playback processing may proceed to step S37.

In step S37, in a case where there is sufficient free space in the audio buffer 4b, the audio data of the frame number L2 stored in the audio cache memory 4a may be copied to the audio buffer 4b. The playback processing may proceed to step S44. Accordingly, the audio data of the frame number L2 copied to the audio buffer 4b may be read at set time intervals by the sound source circuit 8, and may be output from the speaker via the D/A converter 9 and the amp 21.

Thus, in some embodiments, because the RAM 4 can read and write at a high speed, the audio data corresponding to the header (e.g., frame number 1 to frame number N) of the compressed audio data stored in advance (i.e., pre-stored) in the audio cache memory 4a can be read and copied to the audio buffer 4b at a high speed. As such, the audio data corresponding to the header (e.g., frame number 1 to frame number N) of the compressed audio data can be accumulated immediately in the audio buffer 4b. Moreover, because the compressed audio data may be stored in a USB memory 50, which may comprise a high capacity memory capable of storing more data than the RAM 4, but may read and write at a lower speed than the RAM 4, the sound source circuit 8 may be able to output the audio data decoded from the USB memory 50 quickly.

In a case where, during step S37, there is insufficient free space in the audio buffer 4b to store audio data of the frame number L2, the playback processing may wait until there is sufficient free space in the audio buffer 4b. For example, free space may be created as audio data is read and output by the sound source circuit 8. Moreover, in a case where, during step S35, the audio data stored in the audio buffer 4b is less than the prescribed value (S35: No), it may be presumed there is sufficient free space in the audio buffer 4b.

In a case where, during step S33, the value L2 of the second pointer 4h is (N+1) or more (S33: No) (i.e., the audio data to be stored in the audio buffer 4b is frame number (N+1) and after), a determination may be made as to whether or not the post-caching flag 4e is “1” (step S38). In a case where the post-caching flag 4e is not “1” (S38: No) (i.e., no intermediate data obtained from decoding the frame number N), a determination may be made as to whether or not the value L2 of the second pointer 4h is (N+1) (step S39).

In a case where the value L2 of the second pointer 4h is (N+1) (S39: Yes), the RAM 4 may not contain the intermediate data obtained by the decoding process of the frame number N, which may be necessary to decode the frame number (N+1). Accordingly in step S40, the compressed audio data of the frame number N may be read from the compressed audio data stored in the USB memory 50 based on the address stored in the decoding start address 4f. Moreover, the compressed audio data may be decoded, and upon being decoded, the audio data may or may not be destroyed. As a result, the intermediate data obtained by the decoding process of the frame number N, which may be necessary to decode the frame number (N+1), can be stored in the RAM 4. Thus, the frame number (N+1) can be decoded regardless of whether intermediate data was obtained when decoding the header of the compressed audio data.

On the other hand, in some embodiments, the frame number N may not be decoded properly if the decoding process of the frame number (N−1) does not obtain intermediate data. Thus, in some embodiments, because the audio data of the frame number N may be destroyed during step S40, output of the audio data that was not properly decoded may be prevented.

Moreover, because the data input from the USB memory 50 is compressed audio data that has been compression-decoded, the amount of the data may be reduced relative to data that has not been compression-decoded. Accordingly, time required to input data from the USB memory 50 may be reduced. Furthermore, because the compressed audio data of the frame number N may be read from the compressed audio data stored in the USB memory 50 based on the address stored in the decoding start address 4f, the amount of data that needs to be read to decode the frame number N can be minimized. Accordingly, because the compressed audio data may be read forward, there may be no need to search for the compressed audio data corresponding to the frame number N, and thus a burden of the CPU 2 may be reduced. In addition, because the amount of data of the compressed audio that needs to be read to decode the frame number N can be minimized, time required to read compressed audio data from USB memory 50 may be reduced. Thus, for any of these reasons, time and effort in decoding the frame number (N+1) may be reduced.

In a case where, during step S39, the value L2 of the second pointer 4h is not (N+1) (S39: No), the playback processing may skip step S40 and proceed to step S41 because the intermediate data obtained by the decoding process of the frame number N may be unnecessary.

In a case where, during step S38, the post-caching flag 4e is “1” (S38: Yes), the RAM 4 may be regarded as retaining the intermediate data obtained by the decoding process of the frame number N. Accordingly, because further decoding of the frame number N may be unnecessary, and steps S39 and S40 may be skipped, the playback processing may proceed to step S41. For at least this reason, the burden of the CPU 2 may be reduced. Thus, the time and effort to decode the frame number (N+1) may be reduced.

In step S41, the compressed audio data of the frame number L2 may be read from the compressed audio data stored in the USB memory 50, and, accordingly, the compressed audio data may be decoded to produce audio data. Then, in step S42, in a case where there is sufficient free space in the audio buffer 4b, the audio data of the frame number L2 may be stored in the audio buffer 4b. Accordingly, the audio data of the frame number L2 may be read by the sound source circuit 8 and may be outputted from the speaker 22 via the D/A converter 9 and the amp 21. Because the data input from the USB memory 50 is compressed audio data that has been compression-decoded, the amount of the data may be reduced relative to data that has not been compression-decoded. Accordingly, time required to input data from the USB memory 50 may be reduced. In a case where, during step S42, there is insufficient free space in the audio buffer 4b to store audio data of the frame number L2, the playback processing may wait until there is sufficient free space in the audio buffer 4b.

Thus, in some embodiments, steps S38-S42 may reduce time required to perform various tasks or processes, or omit one or more of the processes altogether. Accordingly, remaining frames may be decoded reliably and stored in the audio buffer 4b while audio data of a frame previously stored in the audio buffer 4b may be outputted by the sound source circuit 8.

Next in step S43, the post-caching flag 4e may be set to “0” (S43). Thus, there may be an indication the intermediate data obtained by the decoding process of the frame number N is not held in the RAM 4. Next in step S44, the value L2 of the second pointer 4h may be incremented by 1. Accordingly, the audio data to be stored in the audio buffer 4b can be advanced to a next frame.

Next in step S45, a determination may be made as to whether or not the particular key has been released. In a case where, the particular key has been released (S45: Yes), the playback process may proceed to step S49 to stop playback of the compressed audio, as will be discussed later. On the other hand, in a case where, during step S45, the key has not been released (S45: No), a determination may be made as to whether or not the audio data has been stored in the audio buffer 4b up to the audio data corresponding to a last frame of the compressed audio data (step S46). In a case where audio data has not been stored in the audio buffer 4b up to the audio data corresponding to the last frame of the compressed audio data (S46: No), the playback process may return to step S33. Accordingly, steps S33 to S46 may be carried out with respect to a next frame.

In a case where the audio data has been stored in the audio buffer 4b up to the last frame of the compressed audio data (S46: Yes), steps S33 to S46 may be skipped, and the playback process may proceed to step S47. As such, the audio data may be stored in the audio buffer 4b up to the audio data corresponding to the last frame of the compressed audio data.

In step S47, a determination may be made as to whether or not the loop flag 4d is “1.” In a case where the loop flag 4d is “1” (S47: Yes), the loop flag 4d may be set to loop or repeat playback of the compressed audio data. Next, in step S48, the value L2 of the second pointer 4h may be set to “1.” The playback process may return to step S33. Thus, after audio data corresponding to the last frame of the compressed audio data is stored in or otherwise copied to the audio buffer 4b, audio data corresponding to a lead frame of the compressed audio data may be stored in or otherwise copied to the audio buffer 4b.

On the other hand, in a case where, during step S47, the loop flag 4d is “0” (S47: No), the playback processing may proceed to step 49 because the loop flag 4d is set such that loop playback of the compressed audio data is not executed. In step S49, the sound source circuit 8 may be instructed to stop output of the audio data. Accordingly, the sound source circuit 8 may stop reading the audio data from the audio buffer 4b and may stop the output of the audio data to the D/A converter 9. As such, the output of the audio corresponding to the compressed audio data from the speaker 22 may stop. Upon completion of step S49, the playback processing may end.

In some embodiments, as discussed above, the electronic musical instrument 1 may be configured to store in the audio cache memory 4a audio data corresponding to the header (e.g., frame number 1 to frame number N) of the compressed audio data to be played back in response to a key of the keyboard 6 being operated (e.g., pressed).

Thus, in some embodiments, the electronic musical instrument 1 may be configured to copy the audio data stored in the audio cache memory 4a to the audio buffer 4b in a case where a key to which compressed audio data is assigned is operated (e.g., pressed or released) and there has been a playback start instruction. The audio data then may be outputted from the speaker 22 by the sound circuit 8. As such, audio corresponding to the header (e.g., frame number 1 to frame number N) of the compressed audio data can be played back soon after the key is operated.

In various embodiments, the frame number N is decoded while the audio data corresponding to the header (e.g., frame number 1 to frame number N) of the compressed audio data is outputted from the speaker 22 by the sound source circuit 8. The frame number (N+1) may be decoded based on the frame number N and output after the frame number N.

Accordingly, in a case where there is a playback start instruction (e.g., a key to which compressed audio data is assigned is pressed), the audio data corresponding to frame number (N+1) can be played back continuously to the header (e.g., frame number 1 to frame number N) of the compressed audio data corresponding to the key. As a result, compressed audio data that has been compression-encoded can be played back soon after a playback start instruction.

In various embodiments, prior to a playback start instruction, the compressed audio data corresponding to the header (e.g., frames number 1-number N) of the compressed audio data is decoded and stored in the audio cache memory 4a. Thus, even in a case where the audio compressed data is stored in the USB memory 50, compression-encoded data can be played back soon after a playback start instruction.

In various embodiments, the electronic musical instrument 1 may be configured to play back compressed audio that is compression-encoded in the MP3 format. In other embodiments, the electronic musical instrument 1 and the processing of FIGS. 3-5 may be configured to play back compressed audio compression-encoded in other formats, such as compression-encoding using temporal correlation (e.g., AAC format), or the like.

With reference to FIGS. 1-5, in some embodiments, in order to decode the frame number (N+1) the intermediate data for the frame number N may be necessary. In other embodiments, the frame number (N+1) may be decoded with intermediate data from a sample before the frame number N (e.g., frame number (N−1), (N−2), . . . , 1) according to each compression-encoding method.

In various embodiments, the audio data corresponding to frame number 1 to frame number N may be stored in the audio cache memory 4a. In other embodiments, a size or amount of the audio data stored in the audio cache memory 4a may differ for each compressed audio data that is played back.

In various embodiments, the electronic musical instrument 1 may be configured to decode compressed audio data in the MP3 format. In other embodiments, the electronic musical instrument 1 may be configured to decode compressed audio data in the AAC format. In some embodiments, the electronic musical instrument 1 may be configured to decode compressed audio data that was compressed using any lossy compression or temporal correlation encoding scheme.

In various embodiments, the electronic musical instrument 1 may be configured to decode the compressed audio data corresponding to the header (e.g., frame number 1 to frame number N) of the compressed audio data to produce audio data, and store the audio data in the audio cache memory 4a provided in the RAM 4. In other embodiments, the audio data may be stored in the USB memory 50. In other words, the audio data before compression-encoding (i.e., raw audio data) corresponding to the header may be stored in the USB memory 50. Such embodiments may allow the cache processing steps to be reduced or otherwise omitted, which may reduce the burden on the CPU 2. The compressed-audio data may be the audio data compression-encoded from the previous sample or reference position necessary to play back the audio data following the header stored in the USB 50.

In various embodiments, multiple second pointers 4h may be provided for the keys to which compressed audio data is assigned. In other embodiments, any suitable number of second pointers 4h may be used. For example, a number of second pointers 4h may be the same as a maximum number of musical notes in which an electronic musical instrument 1 can simultaneously play back compressed audio data. In further embodiments, a number of the audio cache memory 4a, the loop flag 4d, the post-caching flag 4e, the decoding start address 4f, and/or the first pointer 4g may be the same as the maximum number of musical notes in which an electronic musical instrument 1 can simultaneously play back compressed audio data. In other embodiments, a number of the audio cache memory 4a, the loop flag 4d, the post-caching flag 4e, the decoding start address 4f, and/or the first pointer 4g may each be one. In such embodiments, the electronic musical instrument 1 may be configured to play back one musical note at a time.

In various embodiments, the electronic musical instrument 1 may include multiple audio buffers 4b for handling the maximum number of musical notes that an electronic musical instrument 1 can play back (e.g., 64 musical notes). The multiple audio buffers 4b and the sound source circuit 8 may be configured for sound production of musical notes. In other embodiments, the electronic musical instrument 1 may include a dedicated audio buffer configured to play back compressed audio data. In such embodiments, the sound source circuit 8 may be configured for sound production of musical notes. Thus, in some embodiments, dedicated audio buffers may be configured to handle the keys to which compressed audio data is assigned. In further embodiments, the dedicated audio buffers may be arranged to handle a maximum number of musical notes in which an electronic musical instrument 1 can simultaneously play back compressed audio data.

In various embodiments, the value of the loop flag 4d or any other flag may be initialized to “0,” for example, when the power source (not shown) of the electronic musical instrument 1 is turned on. In other embodiments, the loop flag 4d or any other flag may be initialized upon any suitable action. For example, the loop flag 4d or any other flag may be initialized (e.g., to “0”) in a case where the playback button 5a is operated (e.g., pressed). In other embodiments, the loop flag 4d or any other flag may be initialized to any suitable value, such as “1,” as opposed to “0.”

In some embodiments, the value of the loop flag 4d or any other flag may be set within the settings file stored in the USB memory 50. In further embodiments, when the power source (not shown) of the electronic musical instrument 1 is turned off, the value of the loop flag 4d or any other flag may be stored in the USB memory 50. Accordingly, the stored value may be read from the USB memory 50, when the power source (not shown) is turned on again. In yet further embodiments, the value of the loop flag 4d or any other flag may be initialized based on the stored value.

In various embodiments, in a case where loop playback is carried out, the electronic musical instrument 1 may be configured to return to a lead frame of the compressed audio data. In other embodiments, the electronic musical instrument 1 may be configured to return to any suitable position. For example, the electronic musical instrument 1 may be configured to play back from an intermediate frame of the header (e.g., frame number 1 to frame number N) of the compressed audio data stored in the audio cache memory 4a.

In various embodiments, compressed audio data may be stored in the USB memory 50. In other embodiments, the compressed audio data may be stored in any suitable storage device, such as, a hard drive, flash memory card (e.g., SD card), xD picture card, compact disc, rewritable compact disc, or the like. In some embodiments, the electronic musical instrument may include internal memory (e.g., a hard drive or flash memory) for storing the compressed audio data.

In some embodiments, the electronic musical instrument 1 may be any device configured or otherwise adapted to play back compressed audio data that has been compression-encoded, for example, using a temporal correlation. For example, a computer or the like may be configured to execute the flowcharts and corresponding processes of FIGS. 3-5. In various embodiments, a device such as the electronic musical instrument 1 may not be limited to playing back musical sounds.

In various embodiments, the electronic musical instrument 1 may be configured to play back audio data that has been compression-encoded. In other embodiments, the electronic musical instrument 1 may be configured to play back any suitable type of compression-encoded data, such as, but not limited to, video, or the like. Furthermore, a device, such as the electronic musical instrument 1, may not be limited to playing back video data that is musical in nature. The video data may be of any subject matter and may or may not include audio data.

The embodiments disclosed herein are to be considered in all respects as illustrative, and not restrictive of the invention. The present invention is in no way limited to the embodiments described above. Various modifications and changes may be made to the embodiments without departing from the spirit and scope of the invention. The scope of the invention is indicated by the attached claims, rather than the embodiments. Various modifications and changes that come within the meaning and range of equivalency of the claims are intended to be within the scope of the invention.

What is claimed is:

1. An audio playback device for playing back audio in response to an audio playback start instruction, the device comprising:
an input means for inputting compressed audio data based on a playback start instruction, the compressed audio data being compression-encoded using temporal correlation;
a decoding means for decoding the compressed audio data input by the input means based on the playback start instruction;
a storage means for storing first audio data corresponding to a header portion of the compressed audio data input by the input means based on the playback start instruction;
a first output means for outputting the first audio data stored in the storage means based on the playback start instruction; and
a second output means for controlling the decoding means to sequentially decode from at least a reference position of the compressed audio data required to decode the compressed audio data corresponding to second audio data that is continuous from a last portion of the first audio data stored in the storage means, the second output means further configured for outputting the second audio data decoded by the decoding means continuous to the first audio data output by the first output means.

2. The audio playback device of 1, the device further comprising
a storage control means for controlling the decoding means to decode the compressed audio data corresponding to the header portion into the first audio data prior to the playback start instruction, the storage control means further configured for storing the first audio data corresponding to the header portion decoded by the decoding means in the storage means.

3. The audio playback device of claim 2, the device further comprising:
a storage position information extraction means for extracting storage position information of at least the reference position of the compressed audio data required to decode the compressed audio data corresponding to the second audio data that is continuous from the last portion of the first audio data stored in the storage means in a case where the decoding means is controlled by the storage control means to decode the compressed audio data corresponding to the header portion;
the input means further configured to sequentially input from at least the reference position of the compressed audio data required to decode the compressed audio data corresponding to second audio data that is continuous from the last portion of the first audio data stored in the storage means based on the storage position information extracted by the storage position information extraction means in a case where the decoding means is controlled to sequentially decode from at least the reference position of the compressed audio data required to decode the compressed audio data corresponding to second audio data that is continuous from the last portion of the first audio data stored in the storage means.

4. An audio playback method, the method comprising:
inputting compressed audio data based on a playback start instruction, the compressed audio data being compression-encoded using temporal correlation;
decoding the inputted compressed audio data based on the playback start instruction;
storing first audio data corresponding to a header portion of the inputted compressed audio data;
outputting the stored first audio data based on the playback start instruction;
sequentially decoding from at least a reference position of the compressed audio data required to decode the compressed audio data corresponding to second audio data that is continuous from a last portion of the stored first audio data; and
outputting the decoded second audio data continuous to the outputted first audio data.

5. A computer-readable audio data storage device for storing audio data usable by an audio data playback device to play back audio in response to a playback start instruction, the device comprising:
non-compressed audio data corresponding to a header of the audio played back by the playback device;
compressed audio data partly overlapped with first audio data corresponding to the non-compressed audio data, the compressed audio data being compression-encoded using temporal correlation, the compressed audio data having at least a reference position of the compressed audio data required to decode the compressed audio data corresponding to second audio data that is continuous from a last portion of the non-compressed audio data.

6. A playback device for playing data based on an instruction, the device comprising:
a processor configured to decode a first portion of compressed data stored in a storage device into first data, the processor further configured to decode a second portion of the compressed data continuous from the first data into second data upon receiving the instruction;
a storage medium for storing the first data;
an output device for outputting the first data upon receiving the instruction and outputting the second data continuous from the first data;
wherein the second portion of the compressed data is decoded based at least partially on the first portion of the compressed data.

7. The playback device of claim 6, wherein the second portion of the compressed data is decoded based on data obtained in decoding the first portion of the compressed data.

8. The playback device of claim 6,
the processor configured to decode the first portion of the compressed data into the first data prior to receiving the instruction; and
the storage medium configured to store the first data prior to receiving the instruction.

9. The playback device of claim 6, wherein the compressed data comprises compressed audio data.

10. The playback device of claim 6, wherein the storage medium comprises random access memory.

11. The playback device of claim 6, the device further comprising:
a first control for providing the instruction.

12. The playback device of claim 11, wherein the first control comprises a keyboard.

13. The playback device of claim 12, the device further comprising:
a second control for assigning a compressed datum from the compressed data to a key of the keyboard.

14. The playback device of claim 6,
wherein the first data includes first intermediate data;
the processor configured to decode the second portion of the compressed data based on the first intermediate data.

15. The playback device of claim 6, the storage medium configured to store location information corresponding to a position of the first portion of the compressed data.

16. The playback device of claim 15, the processor configured to retrieve the position of the first portion of the compressed data based on the location information to decode at least a portion of the second portion of the compressed data.

17. The playback device of claim 15, wherein the position of the first portion of the compressed data is a last portion of the portion of the first portion of the compressed data.

18. The playback device of claim 15, wherein the location information corresponds to an amount of the first data of the compressed data decoded by the processor.

19. The playback device of claim 6, the device further comprising:
a storage device for storing the compressed data.

20. The playback device of claim 6, wherein the compressed data is compressed in at least one of the MPEG-1 Audio Layer 3 format and the Advanced Audio Coding format.

21. The playback device of claim 6, wherein the output device comprises a speaker configured to output first audio corresponding to the first data upon receiving the instruction and to output second audio corresponding to the second data continuous from the first audio.
